(19) United States
(12) Patent Application Publication
(10) Pub. No.: US 2007/0071843 A1
(43) Pub. Date: Mar. 29, 2007

(54) SCRAPING IMPLEMENT ADAPTED FOR USE WITH PUMPKINS AND OTHER FRUITS AND VEGETABLES

(75) Inventors: Trevor Jackson, Kirtland, OH (US); Harry Klaus, Mars, PA (US)

Correspondence Address: CALFEE HALTER & GRISWOLD, LLP, 800 SUPERIOR AVENUE, SUITE 1400, CLEVELAND, OH, 44114, US

(73) Assignee: Emerald Innovations, L.L.C., Butler, PA (US)

(21) Appl. No.: 11/536,379

(22) Filed: Sep. 28, 2006

Related U.S. Application Data
(60) Provisional application No. 60/721,180, filed on Sep. 28, 2005.

(51) Int. Cl. B28B 1/00

(52) U.S. Cl. 425/276; 30/324

(57) ABSTRACT

According to one embodiment of the present invention, a handheld scraping implement is provided that is adapted to scrape, carve and scoop away soft materials including the pulp, seeds and shell of fruits or vegetables, such as pumpkins. The scraping implement comprises a handle portion and a scoop portion. The scoop portion terminates in a scraping blade. In some embodiments of the instant invention, the scraping implement includes a serrated scraping blade and or a beveled or sharpened blade. Furthermore, in some embodiments, the scraping implement includes an optional shaving blade defined within or protruding from the scoop portion. The shaving blade being adapted to shave away portions of the interior or exterior of the shell of the pumpkin or other fruit or vegetable.

### PRIORITY CLAM

The present application claims priority from U.S. Provisional Patent Application Ser. No. 60/721,180 filed on Sep. 28, 2005 for SCRAPING IMPLEMENT ADAPTED FOR USE WITH PUMPKINS AND OTHER FRUITS AND VEGETABLES, the entire disclosure of which is fully incorporated herein by reference.

### TECHNICAL FIELD

The present invention relates generally to a handheld scraping implement useful for a variety of tasks including scraping, carving and scooping soft materials. More particularly, the invention relates to various embodiments of handheld scraping implements adapted to scrape, carve and scoop the pulp, seeds and shell of fruits or vegetables, such as pumpkins.

### BACKGROUND OF THE INVENTION

When carving a pumpkin or other fruit or vegetable, it is common for the carver to remove the pulp, seeds and other vegetable matter from the interior of the pumpkin shell. It is also common for the carver to scrape away or shave away portions of the interior or exterior of the pumpkin shell. The purpose of an embodiment of the present invention, therefore, is to provide a handheld scraping implement adapted to scrape, carve and scoop soft materials such as the pulp, seeds and shell of fruits or vegetables, such as pumpkins.

### SUMMARY OF THE INVENTION

Accordingly, an embodiment of the present invention provides a handheld scraping implement adapted to scrape, carve and scoop away the pulp, seeds and shell of fruits or vegetables, such as pumpkins. The scraping implement comprises a handle portion and a scoop portion. The scoop portion terminates in a scraping blade. In some embodiments of the instant invention, the scraping implement includes a serrated scraping blade and/or a beveled or sharpened blade. Furthermore, in some embodiments, the scraping implement includes an optional shaving blade defined within or protruding from the scoop portion. The shaving blade is adapted to shave away portions of the interior or exterior of the shell of the pumpkin or other fruit or vegetable.

### BRIEF DESCRIPTION OF THE DRAWINGS

FIG. 1 is a perspective view of one embodiment of a scraping implement of the present application;

FIG. 2 is a side view of the scraping implement of FIG. 1;

FIG. 3 is a close up perspective view of the teeth of the scraping implement of FIG. 1;

FIG. 4 is a partial perspective view of a second embodiment of a scraping implement of the present application which includes a shaving blade;

FIG. 5 is a top perspective view of a third embodiment of a scraping implement of the present application; and

FIG. 6 is a bottom perspective view of the scraping implement shown in FIG. 5.

### DETAILED DESCRIPTION OF THE INVENTION

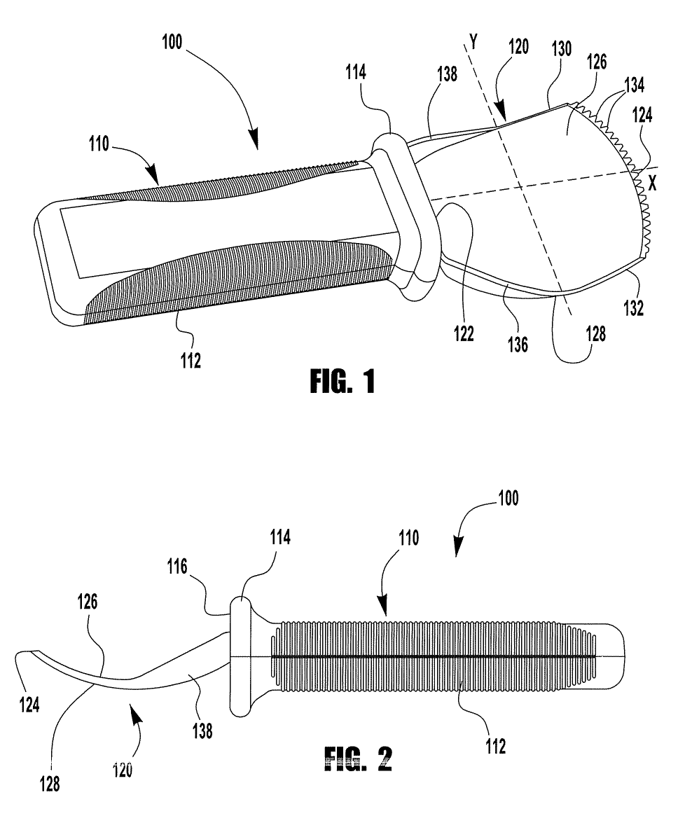

The present application relates to a handheld scraping implement and, in particular, to a scraping implement adapted to scrape, carve and scoop the pulp, seeds and shell of fruits or vegetables, such as pumpkins. The present application is applicable to handheld scraping implements of varying constructions for the carving of pumpkins or other fruits or vegetables. As representative of the invention, FIG. 1 illustrates a handheld scraping implement 100 in accordance with a first embodiment of the invention.

As shown in FIG. 1, the handheld scraping implement 100 of the illustrated embodiment generally includes a handle portion 110 and a scoop portion 120. The handle portion 110 of the scraping implement 100 is molded from plastic but other suitable materials could also be used. In the illustrated embodiment, the handle portion 110 has the general shape of a rectangular prism. It should be apparent to one skilled in the art, however, that the handle could be shaped differently. The handle could be formed in any shape that could be suitably gripped by a user's hand, such as a cylinder or other shape. In additional embodiments of the scraping implement 100, an opening could be defined within the handle portion 110 to receive the fingers or other portion of the user's hand. The handle could also be shaped to ergonomically fit the contours of the human hand. Similarly, indentations or protrusions of various size and orientation could be defined within the surface of the handle portion 110 to accommodate the fingers, thumb or other portion of the user's hand. Finally, it should be apparent that the handle portion 110 could also be produced in various sizes to allow it to be comfortably grasped by both adults and children.

In the illustrated embodiment, a plurality of gripping ridges 112 project from the surface of the handle portion 110. These gripping ridges 112 allow a user to securely grip the handle portion 110 of the scraping implement 100 and prevent it from slipping within a user's hand when being used. The gripping ridges 112 could be sized, shaped and configured in many different ways. In alternative embodiments the gripping ridges 112 could be replaced by a textured surface, or indentations or protrusions defined within the handle portion which allow the user to securely grip the handle portion 110. Conversely, the handle portion 110 could also have a smooth surface and be devoid of any features that facilitate gripping.

The handle portion 110 of the illustrated embodiment includes a guard 114, which is a plate-like member which projects from the handle portion. In the illustrated embodiment, the guard 114 has a flat front surface 116. The guard 114 allows the user to securely grasp the handle portion 110 and prevents the user's hand from slipping down the handle potion 110 towards the scoop portion 120 when using the scraping implement 100. The guard 114 could be shaped, sized and configured differently in additional embodiments, Furthermore, additional embodiments of the scraping implement 100 could be constructed without a guard. It should also be understood that the handle portion 110 and the scoop portion 120 could be provided as a one-piece unitary construction, such as a one-piece plastic extrusion or similar construction, with or without a guard 114.

The scraping implement 100 could also include a hood or sleeve (not shown) attached to the handle portion 110 or the scoop portion 120 of the scraping implement 100. The sleeve surrounds and encloses at least a portion of the user's hand and prevents the user's hand from contacting the surface that is being scraped, such as the interior of a pumpkin shell. It should be understood, however, that the sleeve is not essential and may not be included in all embodiments of the scraping implement 100.

As shown in FIG. 1, the scraping implement 100 includes a scoop portion 120. The scoop portion 120 of the scraping implement 100 is fashioned from metal but other suitable materials, such as plastic, could also be used. The scoop portion 120 of the illustrated embodiment includes a handle end 122, a scraping end 124, a scoop surface 126, a bottom surface 128, and two side edges 130, 132. The handle end 122 includes a mounting element (not shown) that engages with the handle portion 110 to mount the scoop portion 120 onto the handle portion 110. The mounting element could take the form of a post which mounts within the handle portion, a lip which engages with a corresponding groove defined within the handle portion 110 or any other type of fastener, such as an adhesive, a weld, a screw, a rivet, etc. In addition, the handle portion 110 and the scoop portion 120 could be formed together as one piece in a unitary construction.

In the illustrated embodiment, the scraping end 124 of the scoop portion 120 has a curved shape, i.e. when viewed from the top of FIG. 1, with the scraping end curving forward from each of the side edges 130, 132. The scraping end 124 is not limited to this curved shape, however, for the scraping end could have other shapes and could also simply be a straight end generally perpendicular to the side edges 130,132. In the illustrated embodiment, the scraping end 124 includes a plurality of optional scraping teeth 134. It should be understood that the scraping implement 100 could include scraping teeth 134 of various shapes, sizes and configurations. The scraping end 124 could alternatively include serrations of various shapes and configurations or have a blade without any serrations.

In the illustrated embodiment, the scraping end 124 includes a bevel 140 along the scoop surface 126 side of the scraping end 124; however, this bevel 140 may riot be present in all embodiments of the scraping implement 100. The bevel 140 of the illustrated embodiment is formed by the surface of the teeth 134 angling back from the forward edge of the scraping end 124. In addition, the bevel 140 could be located on the bottom surface 128 of the scoop portion 120 or on both the scoop surface 126 and the bottom surface 128. In addition, it should be understood that the scoop portion 120 could include teeth 134 or serrations in combination with a bevel 40 or the scoop portion could include teeth 134 or a bevel 140 separately.

The scoop portion 120 is bounded by the handle end 122, the scraping end 124, and the two side edges 130, 132. The scoop portion 120 of the illustrated embodiment, has a generally trapezoidal shaped scoop surface 126 with the side edges 130, 132 curving outwardly from the handle end 122 to the scraping end 124 when viewed from above, i.e. the top in FIG. 1. It should be apparent to one skilled in the art, however, that the scoop portion 120 could be shaped and configured in different ways and the scoop portion is not limited to this trapezoidal shape. For example, the scoop portion could have a generally square, rectangular, circular, oval or irregular shape. In addition, it is not necessary that the side edges 130, 132 be curved as illustrated; additional embodiments may include straight side edges.

When viewed from the side, i.e. FIG. 2, the scoop portion 120 has a generally curved or arcuate shape. In the illustrated embodiment, the scoop portion 120 has a longitudinal axis X. The scoop portion 120 curves downward from the handle end 122 with respect to axis X until it reaches its lowest point and then curves upwards with respect to axis X and terminates at the scraping end 124. The curvature of the scoop portion 120 generally possesses the shape of a portion of a cylinder. In the illustrated embodiment, the scoop portion 120 has a transverse axis Y. In the illustrated embodiment, the scoop portion is not curved with respect to the transverse axis Y, i.e. in a plane transverse to axis X. In other words, the curvature of the scoop portion 120 does not possess the shape of a portion of a sphere. It should be apparent that the scoop portion 120 could possess various degrees of curvature, could be curved similarly to a portion of a sphere, or could also be straight or have a generally planar shape.

As shown in FIG. 1, the side edges 130, 132 of the scoop portion 120 include raised side walls 136, 138 which project upward from the scoop surface 126 when viewed from the side, i.e. FIG. 2. In the illustrated embodiment, the raised side walls 136, 138 are generally perpendicular to the scoop surface 126, although it should be understood that the side walls 136, 138 could also project from the scoop surface 126 at a variety of angles. In the illustrated embodiment, the raised side walls 136, 138 do not extend the entire length of the side edges 130, 132. Rather, the raised side walls 136, 138 terminate before the scraping end 124 thereby leaving a portion of the side edges 130, 132 without side walls. It should be understood that the scraping element 100 need not have raised side walls 136, 138 and additional embodiments of the scraping element may not include such side walls. In addition, the side walls 136, 138 could extend for a greater or lesser portion of the entire length of the side edges 130, 132 in additional embodiments of the scraping element 100 and could extend the entire length of the side edges as well.

When viewed from the top, i.e. the top of FIG. 1, the side edges 130, 132 of the scoop portion 120 of the illustrated embodiment as well as the side walls 136 and 138 curve with respect to the longitudinal axis X. The side edges 130, 132 curve outward from the handle end 122 with respect to axis X until the side edges 130, 132 reach their outermost point with respect to axis X and terminate at the scraping end 124. Due to the curvature of the side edges 130, 132 of the scoop portion 120 of the illustrated embodiment, the scoop portion 120 of the illustrated embodiment has a generally trapezoidal shape with the scraping end 124 of the scoop being wider than the handle end 122. It should be understand that the shape of the scoop portion 120 and the curvature of the side edges 130,132 may vary widely in additional embodiments. For example the side edges 130, 132 could be generally straight with respect to the longitudinal axis X of the scoop portion giving the scoop a generally rectangular shape. In addition, the scoop portion 120 could have a generally circular or oval shape when viewed from above or could possess a variety of other shapes.

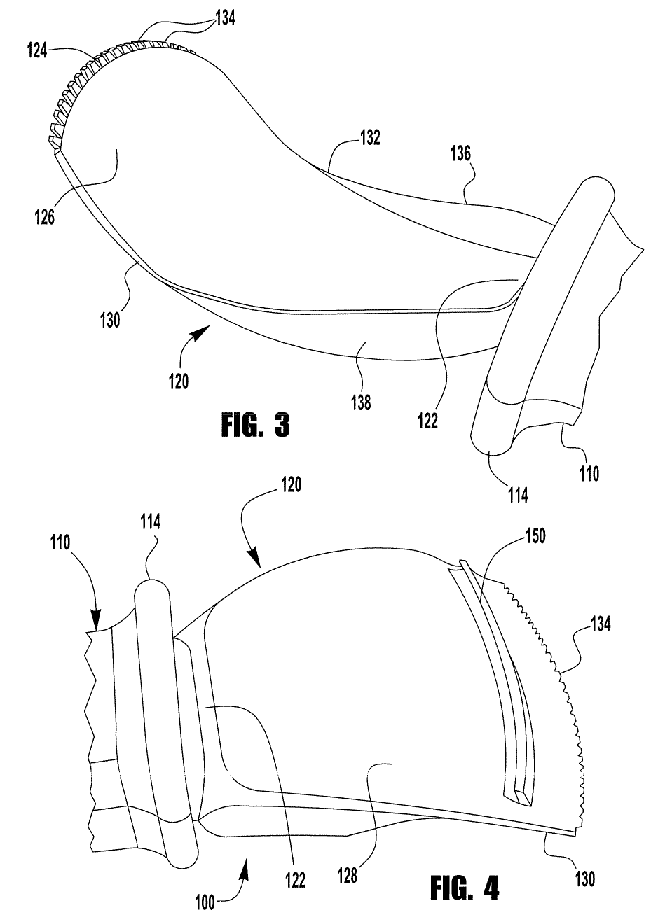

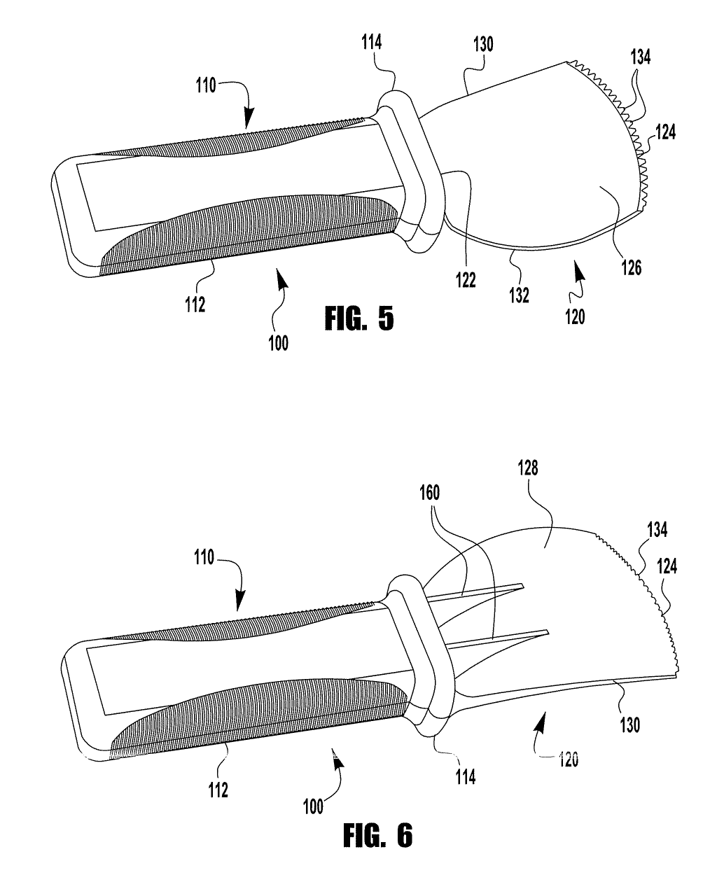

Optionally, the scraping element 100 could also include an optional shaving blade 150 defined within or protruding from the scoop portion 120 as shown in FIG. 4. The shaving blade being a blade adapted to shave away portions of the interior or exterior of the shell of the pumpkin or other fruit or vegetable that is being carved or other soft material. The shaving blade 150 of the illustrated embodiment is a punch-out opening defined within the scoop portion with a blade projecting downward from the bottom surface 128 of the scoop portion 120. However, it should be apparent to those skilled in the art that the shaving blade 150 could be configured and shaped differently. The shaving blade 150 could also project upwardly from the scooping surface 126 of the scoop portion 120. The scraping element 100 could be constructed without a shaving blade or could include a plurality of shaving blades. The shaving blade 150 could be also be a separate component that is attached to either the handle portion 110 or scoop portion 120 of the scraping element 100 and the shaving blade 150 need not be an opening defined within the scoop portion. The shaving blade being a blade adapted to shave away portions of the interior or exterior of the shell of the pumpkin or other fruit or vegetable that is being carved or other soft material.

To use the scraping implement 100 of the illustrated embodiment, the user grasps the handle portion 110 of the scraping implement 100. To begin scraping a surface, the user places the scraping end 124 of the scoop portion 120 against the surface or facing away from the surface that the user desires to scrape with the bottom surface 128 of the scoop portion 120 facing towards the surface and exerts a sufficient force to penetrate the surface as the user maneuvers the scraping end 124 along the surface. The scraping end 124 and optional scraping teeth 134 or optional bevel 140 help to facilitate this scraping. The user can also use the optional shaving blade 150 to shave away a portion of the surface. Once the user has scraped or shaved away the desired amount of material from the surface, the user can then use the scoop portion 120 of the scraping element to scoop up the material and remove it from the surface.

As shown in FIG. 6, the scraping implement 100 may be provided with support braces 160 for supporting the scoop portion 120 of the scraping implement 100. While the scraping implement 100 of the embodiment shown in FIG. 6 includes two support braces 160, any number of support braces could be provided. The support braces 160 could be integrally incorporated into the scoop portion 120 and constructed together with the scoop portion 120 as one piece. The support braces 160 could also be separate from the scoop portion 120 and be connected to or attached thereto. The support braces 160 of the scraping implement 100 illustrated in FIG. 6 help to further support the scoop portion 120 giving it added rigidity and diminishing the likelihood that the scooping portion 120 could break or bend in use. It should be apparent to those skilled in the art, however, that all embodiments of the scraping implement 100 need not include such support braces 160.

It should be understood that the embodiments discussed above are representative of aspects of the invention and are provided as examples and not an exhaustive description of implementations of an aspect of the invention. While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention are described, such as alternative materials, structures, configurations, methods, devices, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated.

1. A scraping element comprising:
a handle;
a scoop portion having a handle end, a scraping end, and a pair of side edges, a length bounded by the handle end and the scraping end, and a width bounded by the side edges;
wherein the scoop portion has a longitudinal axis spanning the length of the scoop portion and a transverse axis spanning the width of the scoop portion;
wherein the scoop portion is curved relative to the longitudinal axis and not curved relative to the transverse axis; and
wherein the scraping end terminates in a plurality of teeth.

2. The scraping element of claim 1 wherein the handle includes a plurality of gripping ridges.

3. The scraping element of claim 1 wherein the handle and scoop portions are formed of plastic.

4. The scraping element of claim 1 wherein the handle portion is formed of plastic and the scoop portion is formed of metal.

5. The scraping element of claim 1 wherein the scraping edge is curved.

6. The scraping element of claim 1 wherein the width of the scoop portion varies along the length such that the scraping end has a width that is greater than the width of the handle portion end.

7. The scraping element of claim 1 wherein the teeth have a scoop surface side and a bottom side and wherein the teeth are beveled on the scoop surface side.

8. The scraping element of claim 1 wherein the teeth have a scoop surface side and a bottom side and wherein the teeth are beveled on the bottom side.

9. The scraping element of claim 1 further comprising a pair of sidewalls, the sidewalls projecting upward from the side edges of the scoop portion along a portion of the length of the scoop portion.

10. The scraping element of claim 9 further comprising a pair of sidewalls, the sidewalls projecting upward from the side edges of the scoop portion along the entire length of the scoop portion.

11. The scraping element of claim 1 wherein the side edges of the scoop portion are curved with respect to the longitudinal axis of the scoop portion.

12. The scraping element of claim 1 further comprising a shaving blade defined within the scoop portion.

13. The scraping element of claim 1 further comprising at least one support brace for bracing the scoop portion.

14. A scraping element comprising:
a handle;
a scoop portion having a handle end, a scraping end, and a pair of side edges, a length bounded by the handle end and the scraping end, and a width bounded by the side edges;
wherein the scoop portion has a longitudinal axis spanning the length of the scoop portion and a transverse axis spanning the width of the scoop portion;
wherein the scoop portion is curved relative to the longitudinal axis and not curved relative to the transverse axis; and
wherein the scraping end terminates in a beveled edge.

15. The scraping element of claim 14 wherein the handle includes a plurality of gripping ridges.

16. The scraping element of claim 14 wherein the handle and scoop portions are formed of plastic.

17. The scraping element of claim 14 wherein the handle portion is formed of plastic and the scoop portion is formed of metal.

18. The scraping element of claim 14 further comprising a pair of sidewalls, the sidewalls projecting upward from the side edges of the scoop portion along a portion of the length of the scoop portion.

19. The scraping element of claim 14 further comprising a pair of sidewalls, the sidewalls projecting upward from the side edges of the scoop portion along the entire length of the scoop portion.

20. The scraping element of claim 14 wherein the side edges of the scoop portion are curved with respect to the longitudinal axis of the scoop portion.

21. The scraping element of claim 14 further comprising a shaving blade defined within the scoop portion.

22. The scraping element of claim 14 further comprising at least one support brace for bracing the scoop portion.

23. The scraping element of claim 14 wherein the scoop portion has a scoop surface side and a bottom side and wherein the beveled edge of the scraping end is on the scoop surface side.

24. The scraping element of claim 14 wherein the scoop portion has a scoop surface side and a bottom side and wherein the beveled edge of the scraping end is on the bottom side.

25. The scraping element of claim 14 wherein the scraping edge is curved.

26. The scraping element of claim 25 wherein the width of the scoop portion varies along the length such that the scraping end has a width that is greater than the width of the handle portion end.

27. A scraping element comprising:
a handle;
a scoop portion having a handle end, a scraping end, and a pair of side edges, a length bounded by the handle end and the scraping end, and a width bounded by the side edges;
wherein the scoop portion has a longitudinal axis spanning the length of the scoop portion and a transverse axis spanning the width of the scoop portion;
wherein the scoop portion is curved relative to the longitudinal axis and riot curved relative to the transverse axis;
wherein the scraping end terminates in a plurality of teeth;
wherein the scoop portion includes a pair of sidewalls, the sidewalls projecting upward from the side edges of the scoop portion along a portion of the length of the scoop portion; and
wherein the scoop portion is useful for use scraping, carving and scooping soft materials from substrates such as the pulp, seeds and shell of fruits or vegetables, the scraping element.

28. A scraping element comprising:
a handle portion;
a scoop portion having a length defined by a longitudinal axis and bounded at opposing ends of the length by the handle portion and a scraping edge, the scoop portion having a generally cylindrical curvature such that the scraping edge curves toward the handle portion
wherein the scoop portion has a width that is defined by an axis that is transverse to the longitudinal axis and is bounded by a pair of side edges, each side edge comprising a sidewall.

29. The scraping element of claim 28 wherein there is essentially no curvature along the transverse axis.

30. The scraping element of claim 28 wherein the scraping end terminates in either a plurality of teeth or a beveled edge

31. The scraping element of claim 30 wherein the scraping end has a scoop surface side and a bottom side and wherein the scraping end is beveled on the scoop surface side.

32. The scraping element of claim 28 wherein the scraping edge is curved.

33. The scraping element of claim 28 wherein the sidewalls project upward from the side edges of the scoop portion along at least a portion of the length of the scoop portion.

34. The scraping element of claim 33 wherein the sidewalls project upward from the side edges of the scoop portion along the entire length of the scoop portion.

35. The scooping element of claim 26 wherein the width of the scoop portion varies along the length such that the scraping end has a width that is greater than the width of the handle portion end.

36. The scraping element of claim 26 further comprising a shaving blade defined within the scoop portion.
